(19) United States
(12) Patent Application Publication
(10) Pub. No.: US 2003/0059286 A1
(43) Pub. Date: Mar. 27, 2003

(54) System and method for sorting articles

(76) Inventor: Manfred Boller, Hohentengen (DE)

Correspondence Address: Jacob Eisenberg, c/o Siemens AG, PO Box 221634, Munich, Bavaria, D-80506, DE

(21) Appl. No.: 10/170,412

(22) Filed: Jun. 14, 2002

(30) Foreign Application Priority Data
Jun. 19, 2001 (EP) EP01114639.6

(51) Int. Cl. B65G 1/00

(52) U.S. Cl. 414/331.14

(57) ABSTRACT

A system and method are set out for the sorting of articles wherein at least one conveyor belt is used to convey and article to a storage unit. The storage unit comprises a plurality of vertically displaceable storage units having compartments. The compartments are defined by walls which extend at a non-perpendicular angle to the vertically displaceable storage units. The walls of the compartments are adjustable to adjust the space defined by the compartment. The vertically displaceable storage units are individually vertically displaceable so as to receive an article from one direction and make other articles available for removal from a second direction. The storage unit is appropriately rotatable about a central axis.

### BACKGROUND OF THE INVENTION

The present invention relates to a system and apparatus for the sorting of articles. The articles may comprise mailpieces, boxes, CD's, and other items of varying shapes and sizes.

Sorting articles is required in a myriad of applications, including warehousing, postal applications, manufacturing, and the like. Sorting articles are effected by sorting systems generally comprising conveying elements and storage elements. The conveying elements convey articles to storage elements from which the articles are then taken and further processed. Sorting systems tend to be application specific, making special provisions for articles of particular shapes, weights, sizes, special needs and the like.

A method and system for sorting articles is disclosed in DE 19929985A1. Herein, a scheme of sorting is applied whereby the articles to be sorted arc first classified, at a first position, and then partitioned accordingly. A drawback to this method is the space requirement for the various machinery as well as physical displacement of articles

Another method and system for sorting articles is disclosed in EP0888829A2. Herein at least two planar workspaces are required for a rotating sorting drum. The drum comprises multiple compartments. Although the drum conserves workspace by design, the drum is fashioned only to receive objects having a square cross section.

Accordingly, a need exists in the art for an arrangement for sorting articles which conserves workspace while providing flexibility in handling articles of different shapes, weights, and sizes. In addition, given that some articles are more delicate than others, a further need exists for the sorting to be gentle and otherwise non-destructive to the articles being sorted or at least, a system that is flexible to adjust to the special care needs of particular articles.

### BRIEF SUMMARY OF THE INVENTION

An object of the present invention is to sort articles using a system which is flexible in design so as to require a minimum of space if desired. A further object of the present invention is to accommodate articles of various shapes and sizes. Still a further object is to incorporate flexible manners of handling articles so as to accommodate special needs articles, gentle handling, non-stackable, etc. Yet a further object is that the sorting be effected manually, semi-automatically, or automatically, with the design flexibility to be controlled locally or remotely. These and other objects of the present invention are achieved by an inventive system and method for sorting articles as is described below.

The inventive method for sorting articles comprises the steps of conveying an article to a storage unit, said storage unit rotatable about a central axis, said storage unit comprising a plurality of vertically displaceable units, at least one of said vertically displaceable units having at least one storage compartment, said at least one storage compartment defined by opposing top and bottom walls, said walls extending away from the storage unit at a non-perpendicular angle, said at least one compartment having no side walls; and receiving said article within said at least one compartment. The method further comprises the step of: vertically displacing one of said vertically displaceable units so as to align a select one of said at least one compartment with said article. The method still further comprises the step of: rotating said storage unit about said central axis, and removing said article from said compartment. Other method steps are included in the present invention as will be apparent from the description and claims below.

The inventive system comprises a storage unit having a plurality of vertically displaceable units, said storage unit being rotatable about a central axis, and said displaceable units comprising at least one compartment for receiving articles, said at least one compartment formed by opposing top and bottom walls, and said top and bottom walls extending from said storage unit at a non-perpendicular angle, such that said at least one compartment becomes available for loading and unloading of articles through vertical displacement of said vertically displaceable units. The system further comprises at least a first and a second conveying means, said first conveying means located proximate to said storage unit such that articles transported by said first conveying means are conveyed into said at least one compartment, and said second conveying means located proximate to said first conveying means such that articles transported on said second conveying means are conveyed to said first conveying means. Other elements are included in the present invention as will be apparent from the description and claims below.

These and other advantages are set out in the specification and claims below wherein like numerals refer to like elements.

### BRIEF DESCRIPTION OF THE SEVERAL VIEWS OF THE DRAWINGS

FIG. 1 depicts a cross sectional view of a portion of an embodiment of the present system,

FIG. 2 depicts a top down view of a portion of a second embodiment of the present system, and

FIG. 3 depicts a flowchart of a method according to the present invention.

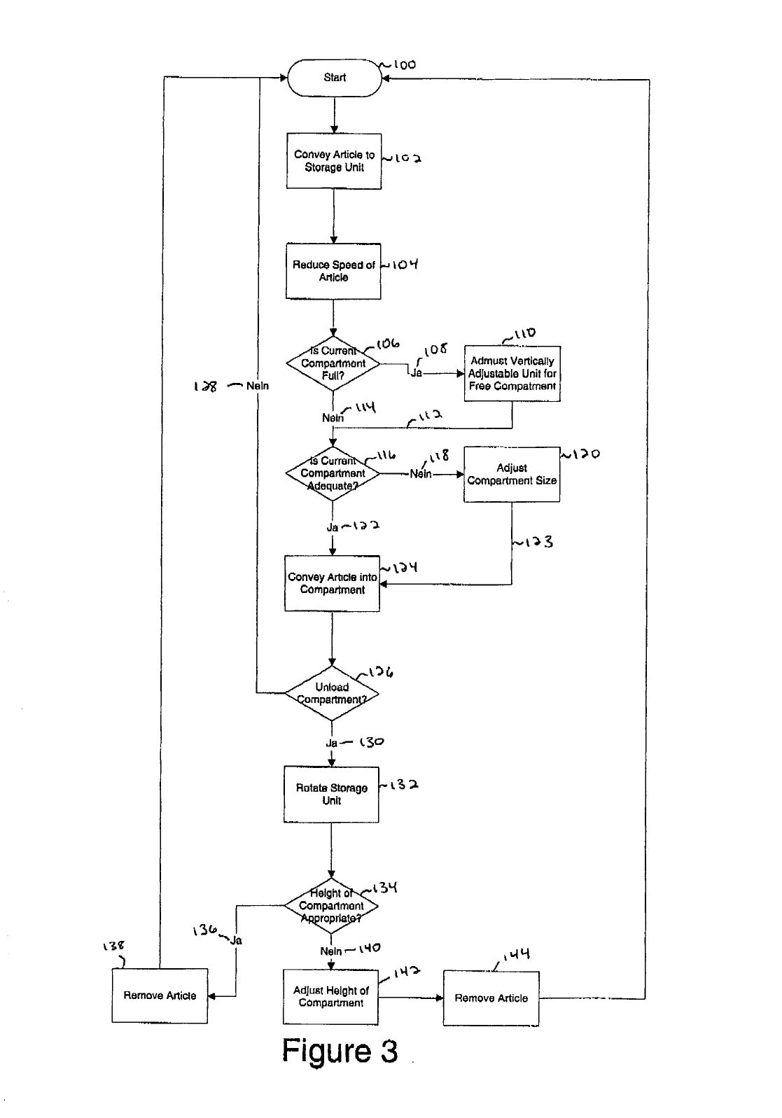

### DETAILED DESCRIPTION OF THE INVENTION

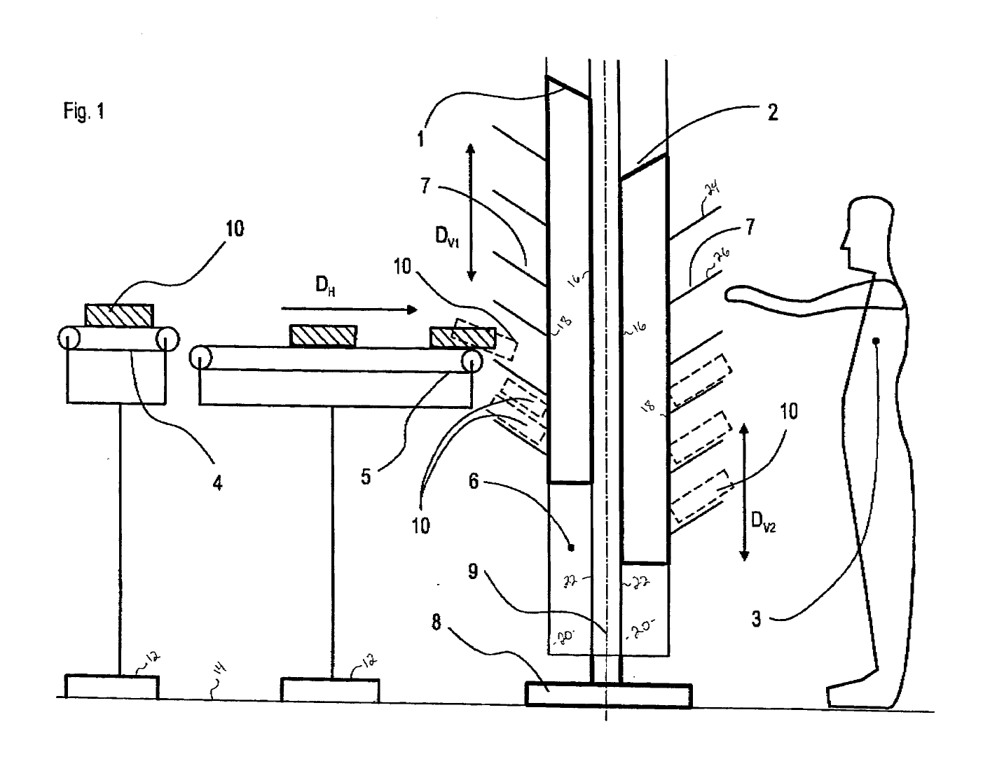

FIG. 1 depicts a cross sectional view of a portion of the present inventive system. Herein, the system comprises a first conveyor belt 5 in conveyor communication with a second conveyor belt 4. The communication facilitates the conveyance of an article 10 from second belt 4 to first belt 5 in the direction D_{H}. The first and second conveyor belts may be non-planar, as shown, or planar (not shown). Furthermore, the two belts may be part of a larger system including additional conveyor belts, article handler, and the like (nor shown). Likewise, the two conveyor belts may be arranged linearly or non-linearly, by a design envisioned by one skilled in the art which facilitates movement or conveyance of the article from a source point (not shown) to storage unit 6. Spatial limitations may also motivate design choice. The height differential between the two belts may also be set to accommodate a soft and smooth transfer of articles. As such, the individual height of the conveyor belts is adjustable by means known to one skilled in the art (not shown). Furthermore, the belts comprise bases 12 which include movement means for displacing the belts about floor 14. The movement means may comprise wheels, rollers and the like (not shown). The displacement of the belts about floor 14 may be facilitated manually, semi-automatically or automatically, with the possible assistance of a belt base drive (not shown). The belt base drive may comprise at least one motor, gear, lever, roller and the like activated by local or remote control signals received through input means, all of which would be known to one skilled in the art. First and second conveyor belts may also be manually, semi-automatically or automatically propelled by a belt drive (not shown). As with the belt base drive, the belt drive may comprise motor(s), gear(s), etc. known to one skilled in the art.

Storage unit 6 comprises a plurality of vertically displaceable units. FIG. 1 depicts storage unit 6 comprising two vertically displaceable units I and 2. Units 1 and 2 are vertically displaceable with respect to the floor 14 in a direction along a storage unit central axis 9. Units 1 and 2, each, comprise a front face 18 and a back face 16. The back faces of the units oppose one another through the central axis 9. The front faces of the units face away from the central axis, and as depicted, towards first conveyor belt 5 and person 3. Accordingly, in operation, and as will be discussed in more detail below, it is possible to simultaneously load an article (e.g. article 10) and unload and another article from the storage unit 6. As such, valuable floor space can be conserved and processing time reduced by the dual use of the storage unit.

Vertically displaceable units I and 2 run along tracks 20 with the back faces 16 engaging track back 22 of tracks 20. The engagement between back face 16 and track back 22 may be via any means known to one skilled in the art which facilitates vertical displacement of the vertically displaceable storage units 1 and 2. Tracks 20 do not necessarily comprise a front track face (in the direction away from central axis 9) which would block access to front face 18, although structural or ornamental front faces (not shown) are envisioned as part of the storage unit.

The front face 18 of vertically displaceable units 1 and 2 comprise compartments 7. The compartments 7 are defined by opposing top and bottom walls 24 and 26 respectively. The top and bottom walls 24 and 26 extend from front face 18 at a non-perpendicular angle. The angle between top and bottom walls 24 and 26 and front face 18 may, for example, comprise approximately 20 degrees. The angle may be altered by means known in the art, to other angles depending upon requirements of a specific application. The altering of the angle may be facilitated by permanent or semi-permanent means, for former comprising a permanent affixing of the wall angle and the later comprising a flexible affixing that can be selectively adjusted manually, semi-automatically, or automatically. For example, where an article needs to be held in a more upright position, the bottom and top walls may be at a greater angle to the front face than 20 degrees. The opposite application would of course require a smaller angle. Where this is known in advance, the walls may be specifically angled prior to receipt of an article. This may be effected by computer means in direct or remote communication with wall angle drive used to re-angle the walls. The interconnection and workings of the computer means with wall angle drive are a matter of design known to one skilled in the art.

As is shown, a bottom wall of one compartment may also be the wall angle of the compartment directly below. The number of compartments and walls are a matter of design choice dependent upon application. The actual location of the top and bottom walls 24, 26, and hence compartments, along front face 1, is flexible. Top and/or bottom walls may be vertically adjusted manually, semi-automatically, or automatically with the possible assistance of a wall vertical drive (not shown). As with drives described above, the vertical wall drives may comprise motor(s), gear(s), etc. as known to one skilled in the art. As such, the compartment height may be adjusted to accommodate a plurality of objects (as shown in FIG. 1), single large objects (not shown), smaller objects (not shown), and the like. In addition, the angle of the walls can be adjusted for special needs articles.

Returning to the storage unit 6, a base 8 is provided to the storage unit 6 to provide support and facilitate movement about floor 14. Base 8, along one face, engages central axis 9 which may further define a supporting structure such as a central metal spine and the like. The storage unit 6 is rotatable about central axis 9 and is thus facilitated via a spinning drive (not shown) and the like. The spinning drive as per drives described above, may comprise motor(s), gear(s), etc. as envisioned by one skilled in the art. Alternatively, the rotating may be manually powered. Base 8, along an opposite face, engages floor 14 with base movement drive (not shown), which like the first and second conveyor belts, comprise wheels, rollers and the like to allow for lateral displacement of the storage unit 6. The mobility incorporated into the bases of the conveyor belts and storage unit facilitates numerous conveyance designs to accommodate different work spaces, conveyor belt types, and the like. In addition, it is possible to easily replace defective elements as well as pull one or more for maintenance. Lastly, the mobility of the conveyor belts and storage unit may be motor assisted and controlled by control signals delivered from an internal or external source. The control signals may be wireline or airborne signals.

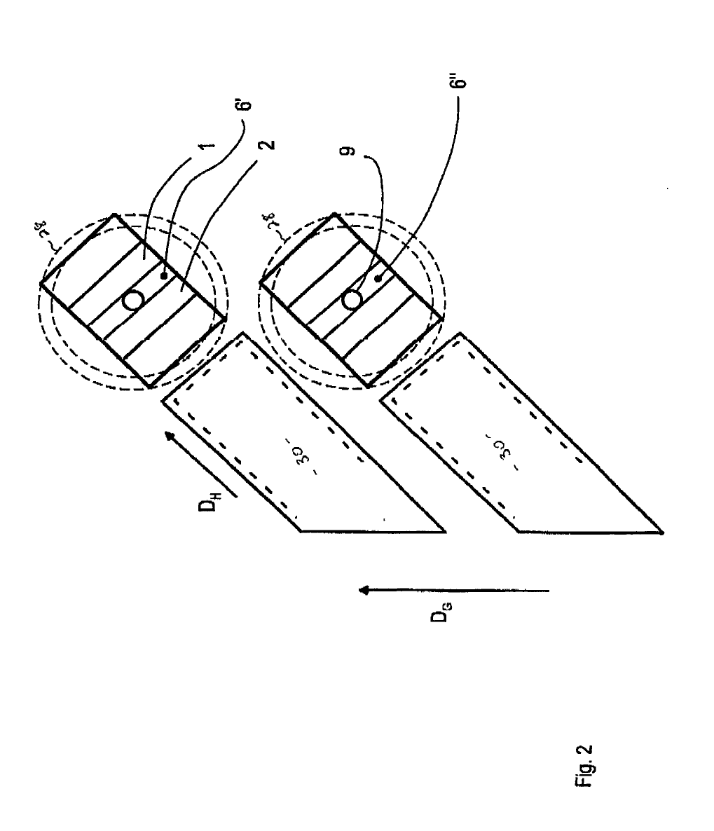

The present system further includes at least one sensor (not shown) positioned along first conveyor belt 5. The sensor may comprise a light barrier sensor, optical scanner, video scanner and the like which facilitates determination of the presence of an article 10 and/or identification of the article. A computer, having a display, processor, input and output means, is also included (not shown) which may be in electrical communication with the sensor and various drives. In addition, the computer may include remote input and output means to receive control signals from an external source as well as transmit control signals to select drives to effect select operations. Accordingly, the computer, in conjunction with the aforementioned drives and sensor, may be used to automate (or semi-automate—with human readable indication and direction) the loading of a select parcel into a select compartment, of select configuration, using select conveyor belts, operating at select speeds. The computer may be a stand-alone or part of a network and its setup, software, and communication is arranged as is known to one skilled in the art to facilitate the aforementioned. FIG. 2 depicts a top down view of an embodiment of the present invention. Herein, two storage units 6′ and 6″ are depicted. The two storage units comprise a central axis 9 about which the storage unit rotates 28. Vertically displaceable units 1 and 2 are depicted proximate and distal to conveyor belts 30. Belts 30 transport items from a distant point, direction D_{G}, to the two storage units in the direction D_{H}.

The method of the present invention will now be described. The method begins at start 100 and proceeds to conveying an article to a select storage unit 102. Prior to reaching the storage unit, the speed of the article is reduced 104. The reduction may be facilitated via a variable speed motor controlled conveyor belt, introduction of a second conveyor belt, manual intervention and the like. A query 106 is made regarding whether the compartment, of the storage unit, aligned to receive the article, is full. If the compartment is full 108, the vertically displaceable unit of the storage unit is vertically displaced 110 so as to align an empty compartment with the incoming article. The method then continues 112 to query 116. If the compartment is not full 114, a query 116 is made whether there is sufficient capacity within the compartment currently aligned to receive the article to receive the article. If there is insufficient capacity 118, the compartment space is adjusted (via wall displacement) 120. The method then proceeds 123 to step 124. If there is sufficient space in the compartment 122, the article is conveyed into the compartment 124. A query is then made regarding whether it is necessary to unload an article 126. If there is no need to unload an article, 128, the method returns to start 100. If there is a need to unload an article 130, then the storage unit is rotated 132. A query is then made as to whether the height of the compartment is appropriate for unloading 134. If the height is appropriate 136, the article is unloaded 138, and the method returns to start 100. This is possible because a second vertical storage unit which faced away from incoming articles now faces the articles. As such, by making simultaneous use of the plurality of vertically displaceable units, it is possible to simultaneously load articles into and unload articles from the storage unit. If the height of the compartment is inappropriate 140, the height is adjusted 142, the article is removed 144, and the method returns to start. The aforementioned queries may be part of a larger sorting routine or a stand-alone routine.

While the present invention has been described above, it is understood by one skilled in the art that alternative embodiments are possible within the above description. Such embodiments include alternative method steps, including determinations of: loading and unloading articles at different times or simultaneously; appropriate storage units and compartments; whether manual, semi-manual, or fully automated loading procedures are to be implemented; whether the storage unit as a whole is to be vertically displaced; whether maintenance is due on a particular part of the invention, whether to reconfigure the conveyance design and to so implement, and so on. As such these and other embodiments are within the scope of the following claims.

1. A method for sorting articles, comprising the steps of;
conveying an article to a storage unit using conveying means, said storage unit rotatable about a central axis, said storage unit comprising a plurality of vertically displaceable units, at least one of said vertically displaceable units having at least one storage compartment, said at least one storage compartment defined by opposing walls, said walls extending away from the storage unit at a non-perpendicular angle, said at least one compartment having no side walls; and
receiving said article within said at least one compartment.

2. The method according to claim 1, further comprising the step of vertically displacing one of said vertically displaceable units so as to align a select one of said at least one compartments with said article.

3. The method according to claim 2, further comprising the steps of;
rotating said storage unit about said central axis, and
removing said article from said compartment.

4. The method according to claim 3, further comprising the step of vertically displacing another of said vertically displaceable units, prior to said step of removing, so as to facilitate removal of said article from said compartment.

5. The method according to claim 4, wherein said vertically displaceable units are independently vertically displaceable.

6. The method according to claim 1, wherein said walls are vertically displaceable.

7. The method according to claim 1, further comprising the step of substantially concurrently loading and unloading articles into and from said storage unit.

8. The method according to claim 6, further comprising the steps of:
determining if sufficient space is present within a compartment prior to loading an article therein, and
if insufficient space is present within said compartment, vertically displacing said walls so as to create sufficient compartment space.

9. The method according to claim 6, further comprising the steps of:
determining if a compartment is empty, prior to loading another article therein,
if said compartment is not empty, determining if it is appropriate to load said another article into said compartment,
if it is appropriate to load said another article into said compartment, determining if there is sufficient space to receive said another article within said compartment,
if there is sufficient space to receive said another article, loading said another article into said compartment,
if there is not sufficient space to receive said another article, vertically displacing said walls so as to create sufficient space to receive said another article,
loading said another article into said compartment, and
if it is inappropriate to vertically displace said walls so as to create sufficient space to receive said another article or if it is inappropriate to load another article into said compartment, vertically displacing said vertically displaceable unit so as to align an empty compartment with said another article.

10. The method according to claim 2, wherein said step of vertically displacing one of said vertical displaceable units is carried out in response to a control signal.

11. The method according to claim 10, wherein said control signal originates with a computer, said computer being in electrical communication with at least one of an article detecting sensor, wall angle drive for angling said walls, wall vertical drive for vertically displacing said vertically displaceable units, belt drive for driving said conveying means, belt base drive for laterally and vertically displacing said conveying means about a floor, spinning drive for rotating said storage unit about said central axis and storage unit base drive for laterally and vertically displacing said storage unit.

12. The method according to claim 11, wherein said sensor identifies said article.

13. The method according to claim 11, wherein said sensor is a barrier sensor.

14. The method according to claim 11, wherein said computer is used to reconfigure design of said conveying means so as to incorporate select routes for select articles to be loaded into select compartments of select sizes within select storage units.

15. The method according to claim 1, wherein said vertically displaceable units are manually displaceable.

16. The method according to claim 1, wherein said conveying means comprises at least a first and a second conveyor belt in conveying communication with each other, said first conveyor belt located proximate to said storage unit and said second conveyor belt located distal to said storage unit, said first conveyor belt having a reduced conveyance speed to said second conveyor belt such that articles traveling on said first conveyor belt enter said compartment at a reduced speed to article travel rate on said second conveyor belt.

17. A system for sorting articles comprising a storage unit having a plurality of vertically displaceable units, said storage unit being rotatable about a central axis, and said displaceable units comprising at least one compartment for receiving articles, said at least one compartment formed by opposing top and bottom walls, and said top and bottom walls extending from said storage unit at a non-perpendicular angle such that said at least one compartment becomes available for loading and unloading of articles through vertical displacement of said vertically displaceable units.

18. The system according to claim 17, further comprising conveying means for conveying said articles from a source to said storage unit.

19. The system according to claim 18, further comprising:
storage unit base drive means for laterally and vertically displacing said storage unit, and
vertically displacing drive means for vertically displacing said vertically displaceable units.

20. The system according to claim 19, further comprising:
wall angle drive means for effecting a select angle to said top and bottom walls, and
wall vertical drive means for effecting vertical displacement of at least one of said top and bottom walls.

21. The system according to claim 20, farther comprising:
belt drive means for driving said conveying means at select speeds,
belt base drive means for laterally and vertically displacing said conveying means,
spinning drive means for rotating said storage unit about said central axis,
sensor means for detecting the presence and/or identification of an article on said conveying means, and
computer means connected to each of said drive means such that control signals from said computer means engages a select one of said drive means such that select articles are conveyed at select speeds, along select conveying routs, to select compartments of select dimensions, within select storage units.

22. The system according to claim 17, further comprising at least a first and a second conveying means, said first conveying means located proximate to said storage unit such that articles transported by said first conveying means are conveyed into said at least one compartment, and said second conveying means located proximate to said first conveying means such that articles transported on said second conveying means are conveyed to said first conveying means.

23. The system according to claim 22, wherein said first conveying means conveys articles at a slower speed than said second conveying means.

24. The system according to claim 23, further comprising sensor means, positioned along said first conveying means.

25. The system according to claim 24, wherein said storage unit father comprises a first drive means for vertically displacing said displaceable units, said first and second conveying means further comprise a second drive means for effecting conveyance of said first and second conveyance means and the system further comprises a computer in communication with said sensor means and first and second drive means, so as to effect conveyance of a select article into a select compartments.
